(19) United States
(12) Patent Application Publication
(10) Pub. No.: US 2023/0388598 A1
(43) Pub. Date: Nov. 30, 2023

(54) SYSTEMS AND METHODS FOR ENABLING ARTIFICIAL REALITY COMMENTARY

(71) Applicant: META PLATFORMS TECHNOLOGIES, LLC, Menlo Park, CA (US)

(72) Inventor: Colleen Kelly Henry, Oakland, CA (US)

(21) Appl. No.: 17/347,695

(22) Filed: Jun. 15, 2021

(51) Int. Cl. H04N 21/478; H04N 21/2187; G06T 19/00; H04N 21/218; H04N 21/81

(52) U.S. Cl. CPC H04N 21/478; H04N 21/2187; G06T 19/006; H04N 21/21805; H04N 21/8146

(57) ABSTRACT

A computer-implemented method for enabling artificial reality commentary may include (i) receiving, from a user, user input specifying a visual media item for insertion into an artificial reality environment, (ii) inserting, in response to receiving the user input, the visual media item into the artificial reality environment, (iii) enabling the user to commentate on the visual media item within the artificial reality environment by inserting an avatar of the user into the artificial reality environment, and (iv) enabling at least one additional user to view, from at least one viewpoint within the artificial reality environment, at least a portion of the visual media item and a portion of the avatar of the user commentating on the visual media item within the artificial reality environment. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for enabling artificial reality commentary.

FIG. 2 is a flow diagram of an exemplary method for enabling artificial reality commentary.

FIG. 3 is an illustration of an exemplary artificial reality scene with in-scene commentary.

FIG. 4 is an illustration of an exemplary artificial reality environment with commentary on a two-dimensional media item.

FIG. 5 is an illustration of an exemplary artificial reality environment with commentary on a live media item.

FIGS. 6A and 6B are illustrations of exemplary systems for enabling viewing of artificial reality commentary.

FIGS. 7A and 7B are illustrations of additional exemplary systems for enabling viewing of artificial reality commentary.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for enabling users to commentate on media in an artificial reality (AR) environment. For example, a user may wish to commentate on a recorded movie, a stream of an AR game, a live comedy event, or any of a variety of media types that take place in or can be inserted into an AR environment. In some cases, a user may wish to share this commentary with others, for example by recording the commentary for later transmission and/or streaming the commentary live.

In some embodiments, the systems described herein may enable users to commentate on pre-recorded or live media. For example, one or more users may interact via avatars positioned in an AR movie theater while watching a movie playing on the screen in the AR movie theater. In other examples, the systems described herein may generate avatars for users in the audience of a comedy show in a virtual club. In the case of live media (e.g., a comedy routine, an improv troupe, etc.), the systems described herein may enable commentating users to interact with the users performing in the media (e.g., heckling, answering questions, giving suggestions, etc.). In some embodiments, the systems described herein may stream and/or record the users' commentary along with the media for consumption by additional users. For example, the systems described herein may enable additional users to spectate silently in the AR environment, watch the combined commentary and media on a mobile device, and/or play a recording of the combined media and commentary after the event has ended.

In some embodiments, the systems described herein may improve the functioning of a computing device by configuring the computing device to enable commentary in AR environments. Additionally, the systems described herein may improve the fields of AR entertainment and/or media commentary by providing efficient tools to enable users to commentate on media items and/or events in an AR environment.

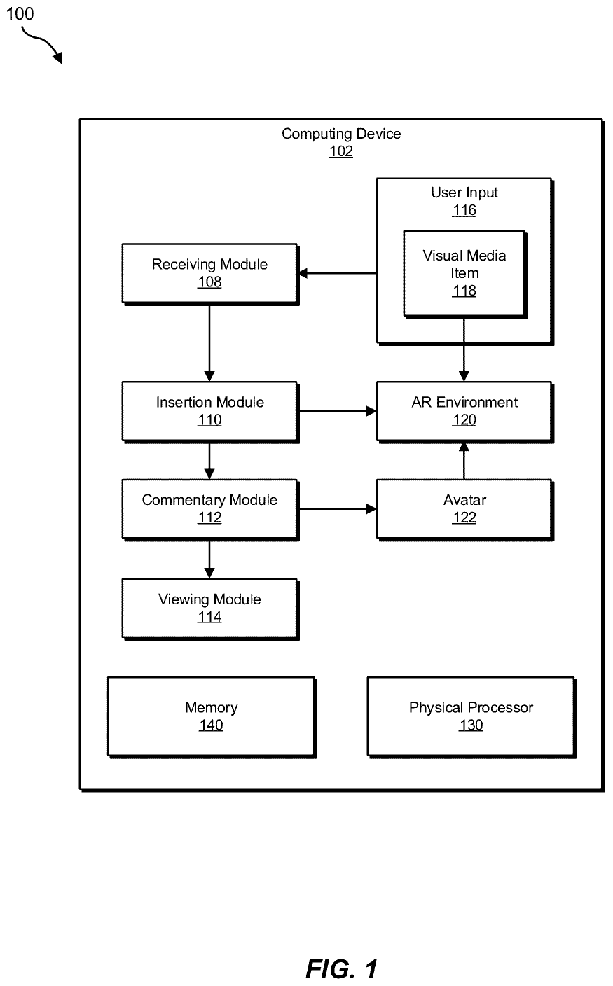

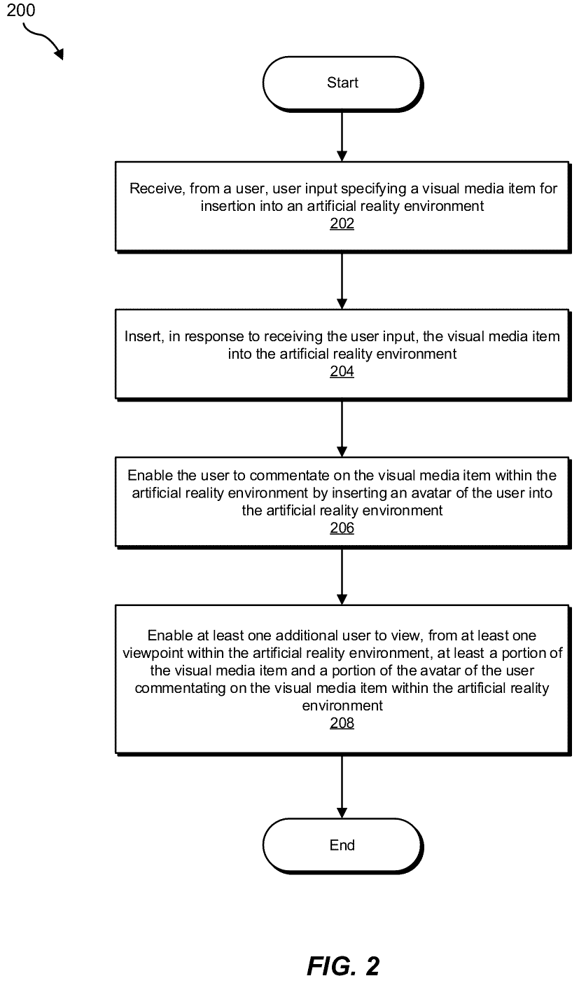

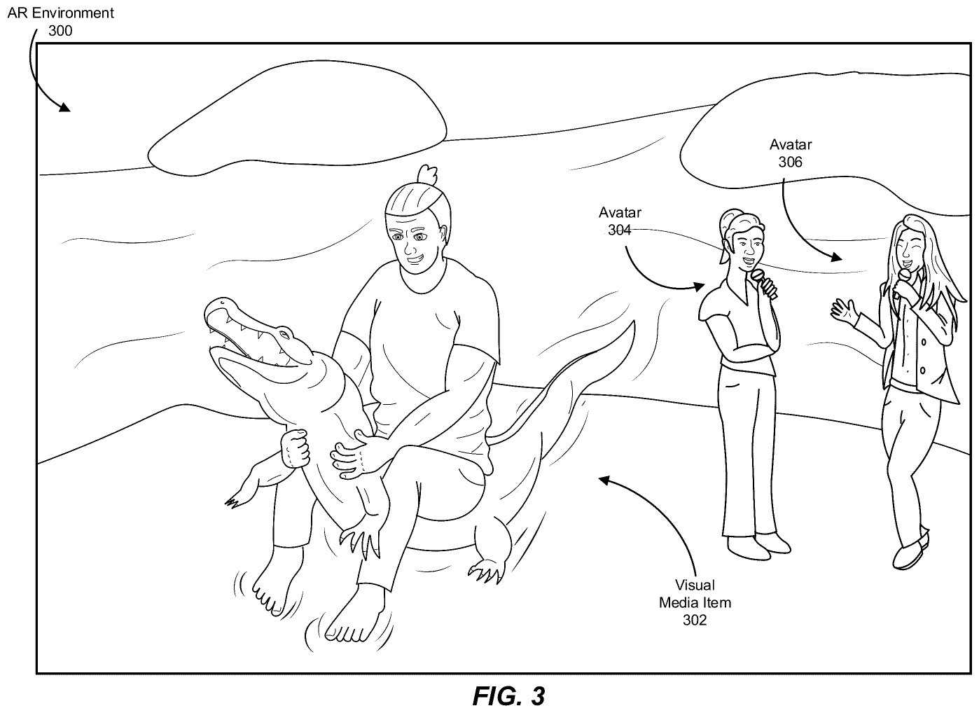

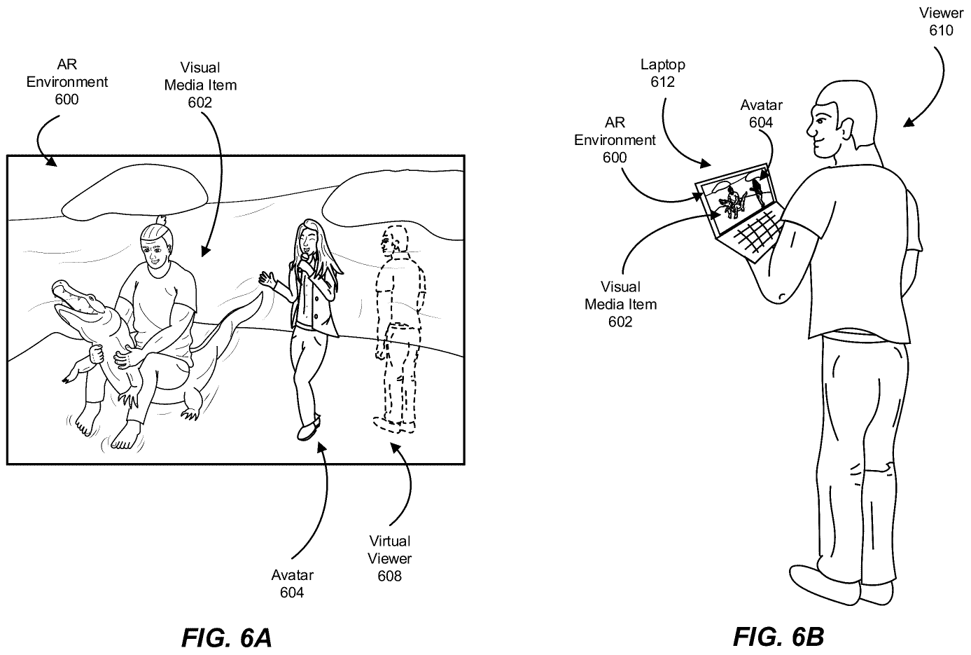

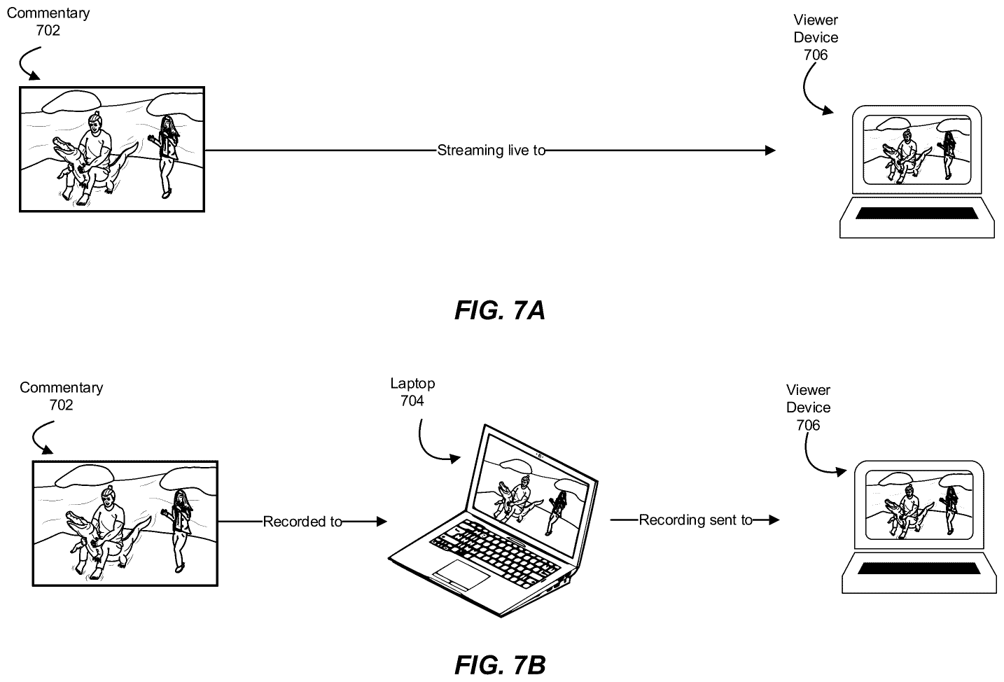

Detailed descriptions of systems and methods for enabling commentary in AR environments will be provided in connection with FIGS. 1 and 2, respectively. Detailed descriptions of different environments and contexts for commentary, such as in-scene, theater-style, and live events, will be provided in connection with FIGS. 3-5. Additionally detailed descriptions of ways and contexts for viewing AR media commentary will be provided in connection with FIGS. 6 and 7.

In some embodiments, the systems described herein may operate partially or entirely on an end user device. FIG. 1 is a block diagram of an exemplary system 100 for enabling commentary in AR environments. In one embodiment, and as will be described in greater detail below, a computing device 102 may be configured with a receiving module 108 that may receive, from a user, user input 116 specifying a visual media item 118 for insertion into an AR environment 120. In some embodiments, an insertion module 110 may insert, in response to receiving user input 116, visual media item 118 into AR environment 120. In one embodiment, a commentary module 112 may enable the user to commentate on visual media item 118 within the AR environment 120 by inserting an avatar 122 of the user into AR environment 120. In some embodiments, a viewing module 114 may enable at least one additional user to view, from at least one viewpoint within AR environment 120, at least a portion of visual media item 118 and a portion of avatar 122 of the user commentating on the visual media item 118 within AR environment 120.

Computing device 102 generally represents any type or form of computing device capable of reading computer-executable instructions. For example, computing device 102 may represent a personal computing device. Examples of computing device 102 may include, without limitation, a laptop, a desktop, a wearable device, a smart device, an artificial reality device, a personal digital assistant (PDA), etc.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 2 is a flow diagram of an exemplary method 200 for enabling AR commentary. In some examples, at step 202, the systems described herein may receive, from a user, user input specifying a visual media item for insertion into an AR environment. For example, receiving module 108 in FIG. 1 may, as part of computing device 102, receive, from a user, user input 116 specifying visual media item 118 for insertion into AR environment 120.

The term “visual media item” may generally refer to any digital content with a visual component. In some embodiments, a visual media item may be dynamic (i.e., not static), such as a video. In one embodiment, a visual media item may include two-dimensional video. Additionally or alternatively, a visual media item may include three-dimensional models and/or environments. In some embodiments, a visual media item may include vector data, raster data, two-dimensional data, three-dimensional data, light fields, meshes, points, clouds, planar data, volumetric data, static visual data, moving visual data, and/or any combination thereof. In some examples, a visual media item may be a pre-existing media recording (e.g., the visual media item may have been recorded in its entirety before any portion of the visual media item is inserted into the AR environment). In other examples, a visual media item may be a live streaming event (e.g., the systems described herein may insert the visual media item into the AR environment as the visual media item is being recorded and/or broadcast). Examples of visual media items may include, without limitation, movies, television shows, sporting events, concerts, videogame playthroughs, and/or theatrical performances.

The term “AR environment” may generally refer to any three-dimensional scene or setting produced by an AR system. AR is a form of reality that has been adjusted in some manner before presentation to a user, which may include, for example, a virtual reality, an augmented reality, a mixed reality, a hybrid reality, or some combination and/or derivative thereof. AR content may include completely computer-generated content or computer-generated content combined with captured (e.g., real-world) content. The AR content may include video, audio, smell, haptic feedback, or some combination thereof, any of which may be presented in a single channel or in multiple channels (such as an optional stereo version of a channel that produces a three-dimensional (3D) effect to the viewer when the correct display is available). In some embodiments, an AR environment may include a three-dimensional scene or setting that includes various three-dimensional models. In one embodiment, an AR system may enable one or more users to explore an AR environment and/or view an AR environment from different viewpoints by moving through the three-dimensional scene.

Receiving module 108 may receive the user input in a variety of ways. For example, the systems described herein may include a graphical user interface via which to receive user input. In some examples, the systems described herein may receive the user input specifying the visual media item by receiving a link and/or reference to a visual media hosted locally (e.g., on the endpoint device configured with the systems described herein and/or a local network to which the endpoint device is connected) and/or remotely (e.g., on a server or additional computing device not on a local network with the endpoint device).

In some embodiments, the systems described herein may enable the user to specify and/or create an AR environment. In one embodiment, the systems described herein may present a user with an interface that enables the user to select from a list of pre-generated AR environments and/or types of AR environments into which to insert the visual media item. In some embodiments, the systems described herein may detect and/or enable the user to specify the format of the visual media item (e.g., two-dimensional versus three-dimensional) and may create a list of pre-generated AR environments based on the format. For example, the systems described herein may generate a list of environments that includes an auditorium with a projector screen, a living room with a large television set, and/or a movie theater in response to determining that the visual media item is two-dimensional and/or that the user has selected an option to insert a two-dimensional version of the visual media item into the AR environment. In another example, the list of environments may include a theater with a stage, a sporting arena, and/or a completely empty environment (e.g., to be populated entirely with content from the visual media item after insertion) if the visual media item is three-dimensional.

Additionally or alternatively, the systems described herein may enable the user to import an AR environment (e.g., from a website and/or from an application that enables user to create and/or download AR environments) and/or create a custom AR environment. In some embodiments, the systems described herein may enable a user to specify the portion of an imported and/or custom AR environment into which to insert the visual media item. For example, the systems described herein may include a user interface that enables a user to specify a display surface within the AR environment for a two-dimensional visual media item and/or a display area within the AR environment for a three-dimensional visual media item. In one example, the systems described herein may enable a user to specify a movie screen within the AR environment as a display surface for a two-dimensional visual media item. In another example, the systems described herein may enable a user to specify the field of a football stadium as a display area for a three-dimensional visual media item.

In some examples, at step 204, the systems described herein may insert, in response to receiving the user input, the visual media item into the AR environment. For example, insertion module 110 in FIG. 1 may, as part of computing device 102, insert, in response to receiving user input 116, visual media item 118 into AR environment 120.

Insertion module 110 may insert the visual media item into the AR environment in a variety of ways. For example, insertion module 110 may insert the visual media item into a specified and/or predetermined portion of the AR environment based at least in part on the format of the visual media item. In one example, insertion module 110 may insert a two-dimensional visual media item into a display surface within the AR environment. For example, insertion module 110 may play a two-dimensional visual media item on a screen within the AR environment. In another example, insertion module 110 may insert a three-dimensional visual media item into a designated zone (e.g., a bounded display area) within an AR environment. For example, insertion module 110 may play a three-dimensional visual media item on a stage within an AR environment. Additionally or alternatively, the entire AR environment may function as a designated zone into which insertion module 110 may insert a three-dimensional visual media item.

In some embodiments, the systems described herein may modify the visual media item prior to and/or as part of inserting the visual media item into the AR environment. For example, the systems described herein may alter the color profile, size, and/or aspect ratio of the visual media item. In some examples, the systems described herein may re-light a virtual object to match the lighting of a virtual scene. In some embodiments, the systems described herein may create a pseudo-three-dimensional version of a two-dimensional rendition of an object. In one example, the systems described herein may create a two-dimensional view of a three-dimensional visual media item for insertion into the AR environment. For example, the systems described herein may select a single camera angle of a three-dimensional scene and may display the view from the camera angle on a display surface within the AR environment. In one example, the visual media item may include a three-dimensional stream of an esports tournament and the systems described herein may play video from a single camera angle of the stream at a time on a movie screen within the AR environment.

In some examples, the systems described herein may insert the visual media item into the AR environment by downloading the entirety of the visual media item before inserting the visual media item into the AR environment (e.g., in the case where the visual media item is a recording). In other examples, the systems described herein may download the visual media item in sections and/or segments, such as in the case of streaming visual media items. In some embodiments, the systems described herein may facilitate spatial streaming (e.g., enabling a user to move a camera around a virtual environment). Additionally or alternatively, the systems described herein may facilitate temporal streaming (e.g., transmitting time-bounded segments of content).

In some examples, at step 206, the systems described herein may enable the user to commentate on the visual media item within the AR environment by inserting an avatar of the user into the AR environment. For example, commentary module 112 in FIG. 1 may, as part of computing device 102, enable the user to commentate on visual media item 118 within the AR environment 120 by inserting avatar 122 of the user into AR environment 120.

The term “commentate” may generally refer to any activity where a user speaks and/or signs (e.g., in American Sign Language) about the contents and/or context of a media item. In some examples, a user may commentate on a visual media item while a recording and/or stream of the visual media item plays. For example, a user may commentate on a movie by reacting verbally and/or physically to the events of the movie as they happen. In another example, a user may commentate on a concert by signing the lyrics of the song being sung. In one example, a user may commentate on a sporting event by discussing statistics relevant to players in the event. In some embodiments, a user may commentate on a live media item by interacting with the media item. For example, a user may commentate on a comedy set by heckling the comedian, who may hear the commentary and be able to respond to the heckling in real time. In some examples, a user may commentate on media that already features recorded commentary by another user. In some examples, multiple users may simultaneously commentate on a media item and may interact with each other while commentating.

The term “avatar” may generally refer to any model within an AR environment that represents the user. In some embodiments, an avatar may be visually similar to the user's physical appearance. For example, the systems described herein may generate an avatar for the user based on visual data (e.g., live camera feeds, recordings, etc.) of the user. Additionally or alternatively, the systems described herein may enable the user to design an avatar, select an avatar from a list of pre-generated models, and/or import an avatar from another application.

In some embodiments, the systems described herein may enable a user to move the avatar around the AR environment. In some examples, the avatar may be confined to a specific location within the AR environment. For example, the systems described herein may insert an avatar into a seat in a movie theater, a commentators' box in a sports stadium, and/or a designated zone within an AR environment and may not enable the avatar to leave that location (e.g., may prevent the avatar from leaving the location).

In some embodiments, the systems described herein may enable the avatar to interact with objects in the AR environment. For example, the systems described herein may enable the avatar to pick up objects, move objects, and/or change the state of objects (e.g., turn a TV on or off). In some examples, the systems described herein may not enable the avatar to interact with objects within the visual media item. For example, if the visual media item is a three-dimensional recording of a football game, the systems described herein may enable the avatar to walk onto the football field but may not enable the avatar to interact with the football or the players. In other examples, the systems described herein may enable the avatar to interact with objects within the visual media item. For example, if the visual media item is a three-dimensional “behind the scenes” feature of a movie, the systems described herein may enable the avatar to interact with props on the movie set.

In some embodiments, the systems described herein may enable the user to manipulate various features of the visual media item. For example, the systems described herein may enable the user to play, pause, rewind, and/or fast forward the visual media item. In some embodiments, the systems described herein may enable the user to raise or lower volume levels in the visual media item and/or selectively enable or mute audio channels. For example, the systems described herein may enable a user to turn on a director's commentary audio track on the movie on which the user is commentating and/or turn down the sound of explosions in the movie while the user is speaking. In another example, the systems described herein may enable the user to turn down and/or mute the audio of professional commentators at a sporting event on which the user is commentating. In some examples, the systems described herein may enable a user to activate, inactivate, and/or modify graphics in a visual media item. For example, the systems described herein may enable a user to turn on subtitles in one or more languages for a television show on which the user is commentating.

In some examples, at step 208, the systems described herein may enable at least one additional user to view, from at least one viewpoint within the AR environment, at least a portion of the visual media item and a portion of the avatar of the user commentating on the visual media item within the AR environment. For example, viewing module 114 in FIG. 1 may, as part of computing device 102, enable at least one additional user to view, from at least one viewpoint within AR environment 120, at least a portion of visual media item 118 and a portion of avatar 122 of the user commentating on the visual media item 118 within AR environment 120.

Viewing module 114 may enable the additional user to view the visual media item and avatar in a variety of ways. For example, viewing module 114 may enable the additional user to view the visual media item and avatar from within the AR environment (e.g., via an AR interface, such as a headset). In another example, viewing module 114 may produce a two-dimensional view of the visual media item and the avatar (e.g., the view from one or more virtual cameras within the AR environment) and may enable the additional user to view the two-dimensional view on a rectilinear display surface of a device (e.g., a mobile phone screen).

In some embodiments, the systems described herein may enable additional users to commentate on the visual media item within the AR environment alongside the first user. For example, as illustrated in FIG. 3, the systems described herein may insert a visual media item 302, such as a livestream of a user playing a popular alligator-wrestling game, into an AR environment 300, such as an outdoor area with water and mud suitable for alligator wrestling. In one example, the systems described herein may insert an avatar 304 into AR environment 300 to enable a user to commentate on visual media item 302. In some examples, the systems described herein may also insert an avatar 306 into AR environment 300 to enable an additional user to join the first user in commentating. In some embodiments, the systems described herein may enable avatar 304 to interact with avatar 306. In some examples, the systems described herein may enable the two users to commentate together by enabling the users to hear one another's audio and/or see each other's avatars in real time. In some examples, the systems described herein may enable viewers to view avatar 304 and/or avatar 306 commentating on visual media item 302 from any of a variety of viewpoints within AR environment 300. In one example, the systems described herein may enable a viewer to control a virtual camera within AR environment 300 that can view the scene from any angle.

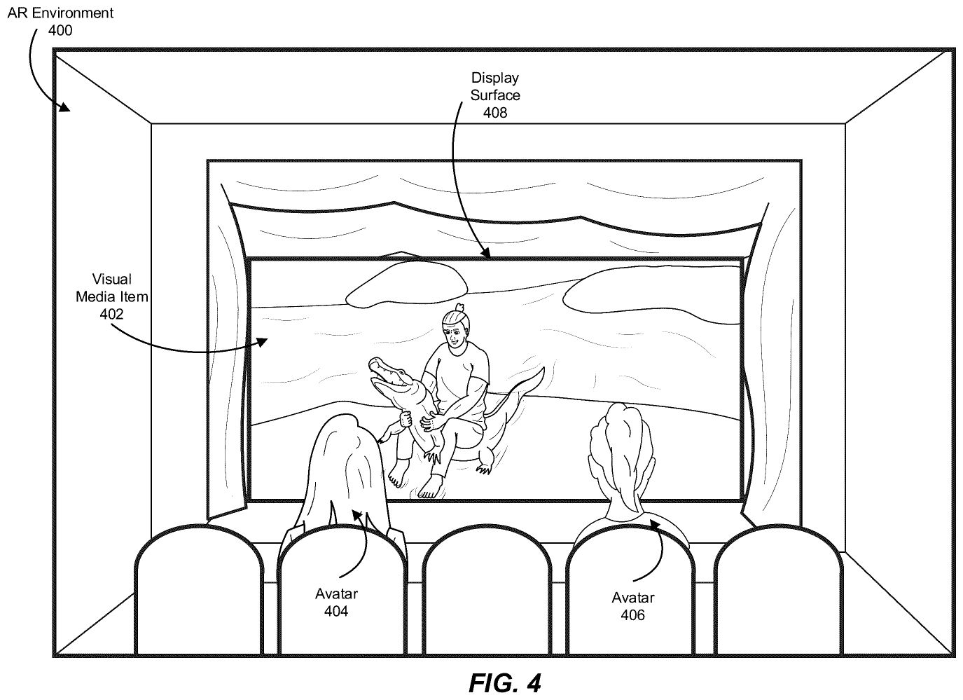

In some embodiments, the systems described herein may enable one or more users to commentate on a two-dimensional visual media item and/or a two-dimensional version of a three-dimensional visual media item. For example, as illustrated in FIG. 4, the systems described herein may insert a visual media item 402 into a display surface 408 of an AR environment 400, such as a screen in a movie theater. In one example, the systems described herein may insert an avatar 404 and/or an avatar 406 into AR environment 400, for example by inserting the avatars into seats in the movie theater.

In some examples, rather than enabling viewers to view avatar 404 and/or avatar 406 commentating on visual media item 402 from any viewpoint, the systems described herein may constrain viewers to one or more viewpoints specified by the user who initiated the AR environment and/or by a setting within the configuration of the AR environment. For example, the systems described herein may only enable viewers to view the scene from a viewpoint within a seat in the movie theater. In another example, the systems described herein may constrain viewers to a viewpoint at the very back of the movie theater, with the virtual camera pointing directly at display surface 408 with avatar 404 and/or avatar 406 in the foreground.

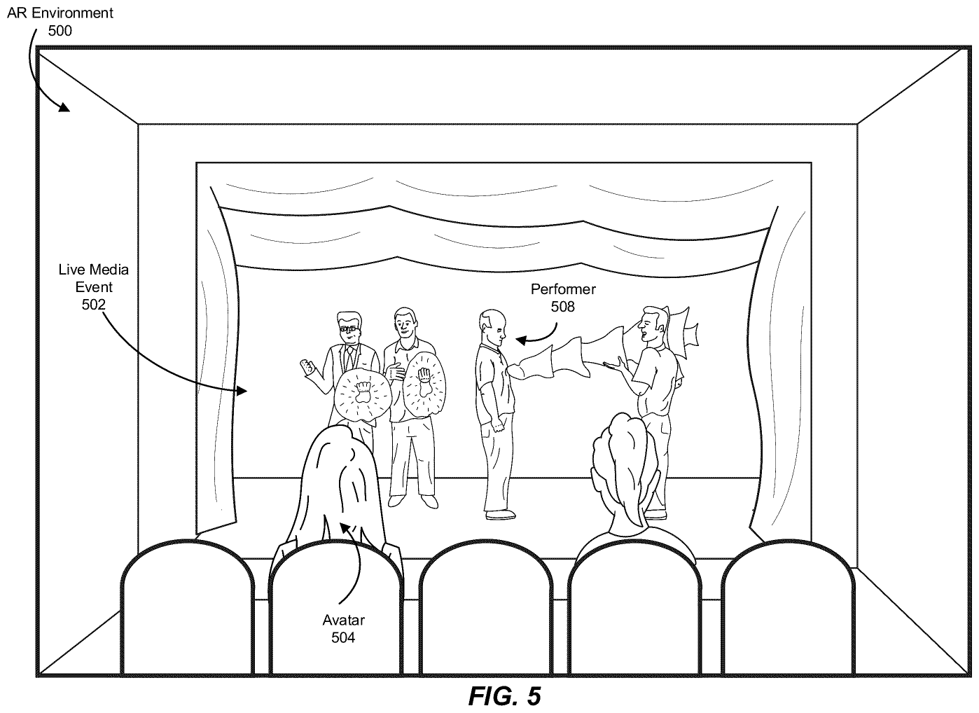

In some embodiments, the systems described herein may enable the user to interact with one or more performers in a live visual media event. In one example, as illustrated in FIG. 5, the systems described herein may insert a live media event 502 that includes a performer 508 into an AR environment 500. For example, performer 508 may be a performer in a live improvisational comedy show. In one example, the systems described herein may insert an avatar 504 of the user into AR environment 500 and enable the user to, via avatar 504, interact with performer 508. For example, the systems described herein may enable the user to speak to performer 508 (e.g., asking or answering questions) and/or may enable avatar 504 to get on stage and interact directly with performer 508 (e.g., holding props as part of a comedy skit). In some embodiments, the systems described herein may enable the user to control whether the user's audio is audible to performer 508 or not. For example, the systems described herein may enable the user to mute their audio feed to performer 508 (but not to other commentators and/or viewers) when the user is commentating on a skit being performed by performer 508 and unmute their audio feed when the user is answering a question that performer 508 is asking the audience.

In some embodiments, the systems described herein may enable one or more viewers to view the visual media item and avatar in a variety of different formats and/or on a variety of different types of devices. For example, as illustrated in FIG. 6A, the systems described herein may enable a viewer 610 to view an avatar 604 commentating on a visual media item 602 within an AR environment 600 by inserting a virtual viewer 608 into AR environment 600. In some embodiments, virtual viewer 608 may represent a virtual camera and may not be visible to other users (including the commentator). Additionally or alternatively, virtual viewer 608 may represent an avatar of viewer 610 that may be visible to the commentator and/or other viewers. In some embodiments, the systems described herein may enable virtual viewer 608 to move around AR environment 600 to view avatar 604 and/or visual media item 602 from various viewpoints. In one embodiment, viewer 610 may view AR environment 600 via a specialized device, such as an AR headset. In some embodiments, the positioning of virtual viewer 608 may affect the audio sent to viewer 610. For example, if virtual viewer 608 is near avatar 604, viewer 610 may hear avatar 604 commentating, while if virtual viewer 608 is far away from avatar 604 (e.g., a distance that would be out of earshot in a physical space), the systems described herein may not send audio to viewer 610 from avatar 604. Additionally or alternatively, the systems described herein may enable viewer 610 to hear commentary regardless of the positioning of virtual viewer 608.

Additionally or alternatively, the systems described herein may enable viewer 610 to view the commentary via a non-AR device, such as a laptop, tablet, or mobile phone. For example, as illustrated in FIG. 6B, the systems described herein may enable viewer 610 to view avatar 604 commentating on visual media item 602 within AR environment 600 via a laptop 612. In some embodiments, the systems described herein may select a single viewpoint for two-dimensional viewing of the commentary. Additionally or alternatively, the systems described herein may enable viewer 610 to switch between multiple pre-selected viewpoints within AR environment 600 and/or to move a virtual camera freely within AR environment 600.

In some examples, the systems described herein may enable viewer 610 to view the commentary live and/or in a recorded form. If the commentary is recorded, the systems described herein may enable viewer 610 to pause, rewind, fast forward, and/or otherwise manipulate the playback of the recording of the commentary.

In some embodiments, the systems described herein may enable a user to livestream the user's commentary (e.g., send the commentary to one or more viewers in real time). Additionally or alternatively, the systems described herein may enable the user to record the commentary for editing and/or later transmission. For example, as illustrated in FIG. 7A, the systems described herein may enable a user to create a commentary 702 of an avatar of the user commentating on a visual media item in an AR environment and to livestream commentary 702 to a viewer device 706 as commentary 702 is being created. While illustrated as a direct transmission, in many embodiments, the systems described herein may upload commentary 702 to a server (e.g., a cloud server) from which viewer device 706 may download commentary 702. In another example, as illustrated in FIG. 7B, the systems described herein may enable a user to create commentary 702 (e.g., via an AR device) and record commentary 702 to another device, such as a laptop 704. In one example, the user may edit commentary 702 on laptop 704 (e.g., by adjusting audio levels, cutting scenes, adding scene transitions, adding graphical or audio effects, etc.) before making commentary 702 available for download by viewer device 706.

As described above, the systems and methods described herein may enable media commentary in AR by providing a user with an interface that enables the user to select a media item, insert the media item into an AR environment of the user's choice, and then commentate on the media item within the AR environment via an avatar. In this way, the systems described herein may enable users to create immersive commentary-based entertainment for consumption by other users. For example, a user may record themself having comedic reactions to a bad movie or may stream themself providing niche commentary on a sporting event that's of interest to a subset of users who are not served by professional commentary. By enabling viewers to view the commentary on a variety of devices, the systems described herein may enable creators to reach a large audience of potential viewers while providing a high-quality viewing experience.

Embodiments of the present disclosure may include or be implemented in conjunction with various types of artificial reality systems. As described above, artificial reality is a form of reality that has been adjusted in some manner before presentation to a user. Additionally, in some embodiments, artificial reality may also be associated with applications, products, accessories, services, or some combination thereof, that are used to, for example, create content in an artificial reality and/or are otherwise used in (e.g., to perform activities in) an artificial reality.

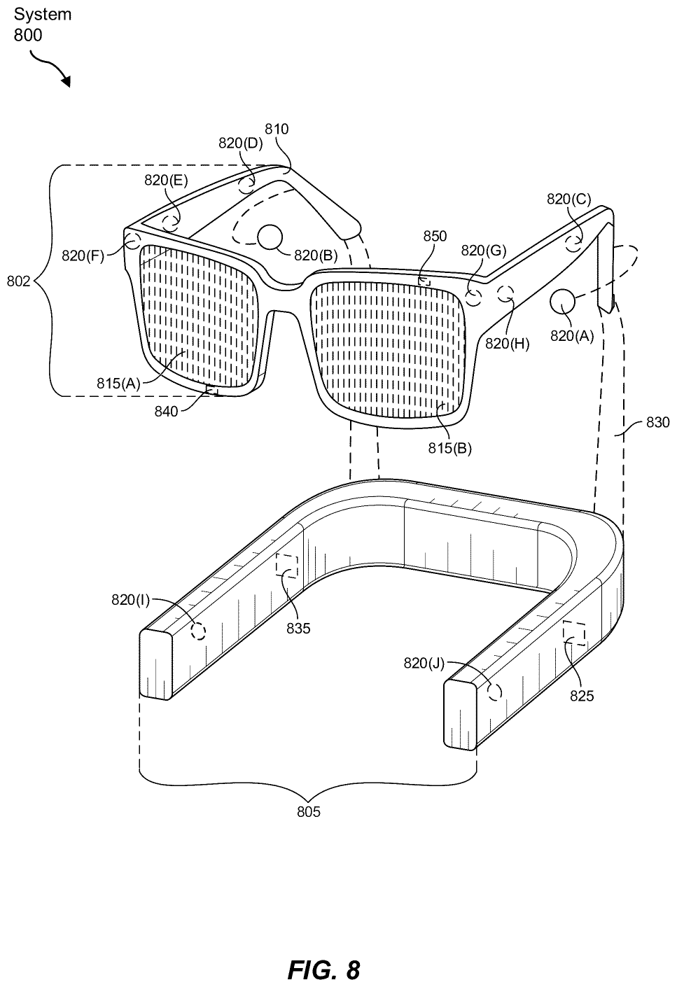

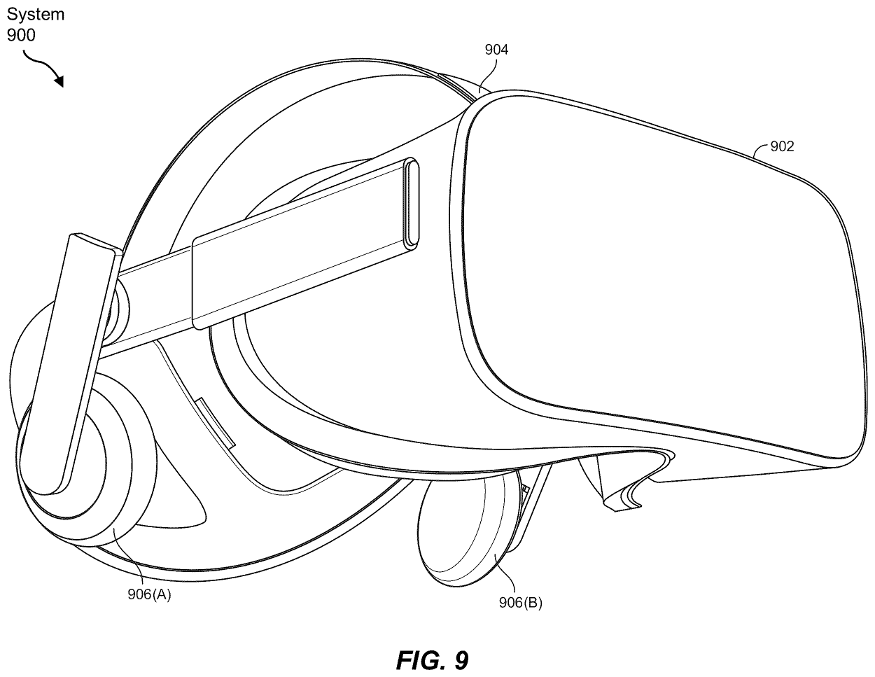

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-120(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(1) and 820(J)) that are part of the microphone array (or potentially form their own microphone subarray). Neckband 805 may also include a controller 825 and a power source 835.

Acoustic transducers 820(1) and 820(J) of neckband 805 may be configured to detect sound and convert the detected sound into an electronic format (analog or digital). In the embodiment of FIG. 8, acoustic transducers 820(1) and 820(J) may be positioned on neckband 805, thereby increasing the distance between the neckband acoustic transducers 820(1) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

### EXAMPLE EMBODIMENTS

Example 8: A method for enabling artificial reality commentary may include (i) receiving, from a user, user input specifying a visual media item for insertion into an artificial reality environment, (ii) inserting, in response to receiving the user input, the visual media item into the artificial reality environment, (iii) enabling the user to commentate on the visual media item within the artificial reality environment by inserting an avatar of the user into the artificial reality environment, and (iv) enabling at least one additional user to view, from at least one viewpoint within the artificial reality environment, at least a portion of the visual media item and a portion of the avatar of the user commentating on the visual media item within the artificial reality environment.

Example 9: The computer-implemented method of example 1, where the visual media item includes a two-dimensional video and inserting the visual media item into the artificial reality environment includes playing the two-dimensional video on a display surface within the artificial reality environment.

Example 3: The computer-implemented method of examples 1-2, where the visual media item includes three-dimensional content and inserting the visual media item into the artificial reality environment includes inserting the three-dimensional content into a designated zone within the artificial reality environment.

Example 4: The computer-implemented method of examples 1-3, where the visual media item includes a live media event and inserting the visual media item into the artificial reality environment includes streaming the live media event within the artificial reality environment.

Example 5: The computer-implemented method of examples 1-4 may further include enabling the user to interact in real time with at least one performer performing in the live media event.

Example 6: The computer-implemented method of examples 1-5, where the visual media item includes a recording and inserting the visual media item into the artificial reality environment includes inserting the recording into the artificial reality environment.

Example 7: The computer-implemented method of examples 1-6, where receiving the user input specifying the visual media item includes receiving a selection of a type of artificial reality environment into which to insert the visual media item.

Example 8: The computer-implemented method of examples 1-7 may further include enabling an additional commentator to commentate with the user on the visual media item within the artificial reality environment by inserting an avatar of the additional commentator into the artificial reality environment.

Example 9: The computer-implemented method of examples 1-8, where enabling the at least one additional user to view the avatar of the user commentating on the visual media item includes enabling the at least one additional user to view avatar of the user commentating on the visual media item via an artificial reality system that enables the at least one additional user to view a three-dimensional version of the artificial reality environment.

Example 10: The computer-implemented method of examples 1-9, where enabling the at least one additional user to view the avatar of the user commentating on the visual media item includes enabling the at least one additional user to view the avatar of the user commentating on the visual media item via a display surface on a computing device that enables the at least one additional user to view a two-dimensional version of the artificial reality environment.

Example 11: The computer-implemented method of examples 1-10, where enabling the at least one additional user to view the avatar of the user commentating on the visual media item includes recording the avatar of the user commentating on the visual media item.

Example 12: The computer-implemented method of examples 1-11, where enabling the at least one additional user to view the avatar of the user commentating on the visual media item includes stream the avatar of the user commentating on the visual media item to the at least one additional user in real time.

Example 13: A system for enabling artificial reality commentary may include at least one physical processor and physical memory including computer-executable instructions that, when executed by the physical processor, cause the physical processor to (i) receive, from a user, user input specifying a visual media item for insertion into an artificial reality environment, (ii) insert, in response to receiving the user input, the visual media item into the artificial reality environment, (iii) enable the user to commentate on the visual media item within the artificial reality environment by inserting an avatar of the user into the artificial reality environment, and (iv) enable at least one additional user to view, from at least one viewpoint within the artificial reality environment, at least a portion of the visual media item and a portion of the avatar of the user commentating on the visual media item within the artificial reality environment.

Example 14: The system of example 13, where the visual media item includes a two-dimensional video and inserting the visual media item into the artificial reality environment includes playing the two-dimensional video on a display surface within the artificial reality environment.

Example 15: The system of examples 13-14, where the visual media item includes three-dimensional content and inserting the visual media item into the artificial reality environment includes inserting the three-dimensional content into a designated zone within the artificial reality environment.

Example 16: The system of examples 13-15, where the visual media item includes a live media event and inserting the visual media item into the artificial reality environment includes streaming the live media event within the artificial reality environment.

Example 17: The system of examples 13-16, where the visual media item includes a recording and inserting the visual media item into the artificial reality environment includes inserting the recording into the artificial reality environment.

Example 18: The system of examples 13-17, where receiving the user input specifying the visual media item includes receiving a selection of a type of artificial reality environment into which to insert the visual media item.

Example 19: The system of examples 13-18, where the computer-executable instructions may further include enabling an additional commentator to commentate with the user on the visual media item within the artificial reality environment by inserting an avatar of the additional commentator into the artificial reality environment.

Example 20: A non-transitory computer-readable medium may include one or more computer-readable instructions that, when executed by at least one processor of a computing device, cause the computing device to (i) receive, from a user, user input specifying a visual media item for insertion into an artificial reality environment, (ii) insert, in response to receiving the user input, the visual media item into the artificial reality environment, (iii) enable the user to commentate on the visual media item within the artificial reality environment by inserting an avatar of the user into the artificial reality environment, and (iv) enable at least one additional user to view, from at least one viewpoint within the artificial reality environment, at least a portion of the visual media item and a portion of the avatar of the user commentating on the visual media item within the artificial reality environment.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
receiving, from a user, user input specifying a visual media item for insertion into an artificial reality environment, the visual media item comprising three-dimensional media;
determining, in response to receiving the user input, a format of the visual media item;
configuring, based on the format of the visual media item, the artificial reality environment to display the visual media item within a designated zone of the artificial reality environment, the designated zone comprising a bounded three-dimensional space for displaying three-dimensional media;
inserting the visual media item into the designated zone of the artificial reality environment;
enabling the user to commentate on the visual media item within the artificial reality environment by inserting an avatar of the user into the artificial reality environment; and
enabling at least one additional user to view, from at least one viewpoint within the artificial reality environment, at least a portion of the visual media item and a portion of the avatar of the user commentating on the visual media item within the artificial reality environment.

2. The computer-implemented method of claim 1, wherein:
the visual media item comprises a two-dimensional video; and
configuring the artificial reality environment to display the media item comprises modifying the two-dimensional video for display in the designated zone.

3. The computer-implemented method of claim 1, further comprising re-lighting at least one virtual object to match lighting of at least one of:
the visual media item; or
the artificial reality environment.

4. The computer-implemented method of claim 1, wherein:
the visual media item comprises a live media event; and
inserting the visual media item into the artificial reality environment comprises streaming the live media event within the artificial reality environment.

5. The computer-implemented method of claim 4, further comprising enabling the user to interact in real time with at least one performer performing in the live media event.

6. The computer-implemented method of claim 1, wherein:
the visual media item comprises a recording; and
inserting the visual media item into the artificial reality environment comprises inserting the recording into the artificial reality environment.

7. The computer-implemented method of claim 1, wherein receiving the user input specifying the visual media item comprises receiving a selection of a type of artificial reality environment into which to insert the visual media item.

8. The computer-implemented method of claim 1, further comprising enabling an additional commentator to commentate with the user on the visual media item within the artificial reality environment by inserting an avatar of the additional commentator into the artificial reality environment.

9. The computer-implemented method of claim 1, wherein enabling the at least one additional user to view the avatar of the user commentating on the visual media item comprises enabling the at least one additional user to view avatar of the user commentating on the visual media item via an artificial reality system that enables the at least one additional user to view a three-dimensional version of the artificial reality environment.

10. The computer-implemented method of claim 1, wherein enabling the at least one additional user to view the avatar of the user commentating on the visual media item comprises enabling the at least one additional user to view the avatar of the user commentating on the visual media item via a display surface on a computing device that enables the at least one additional user to view a two-dimensional version of the artificial reality environment.

11. The computer-implemented method of claim 1, wherein enabling the at least one additional user to view the avatar of the user commentating on the visual media item comprises recording the avatar of the user commentating on the visual media item.

12. The computer-implemented method of claim 1, wherein enabling the at least one additional user to view the avatar of the user commentating on the visual media item comprises stream the avatar of the user commentating on the visual media item to the at least one additional user in real time.

13. A system comprising:
at least one physical processor;
physical memory comprising computer-executable instructions that, when executed by the physical processor, cause the physical processor to:
receive, from a user, user input specifying a visual media item for insertion into an artificial reality environment, the visual media item comprising three-dimensional media;
determine, in response to receiving the user input, a format of the visual media item;
configure, based on the format of the visual media item, the artificial reality environment to display the visual media item within a designated zone of the artificial reality environment, the designated zone comprising a bounded three-dimensional space for displaying three-dimensional media;
insert the visual media item into the designated zone of the artificial reality environment;
enable the user to commentate on the visual media item within the artificial reality environment by inserting an avatar of the user into the artificial reality environment; and
enable at least one additional user to view, from at least one viewpoint within the artificial reality environment, at least a portion of the visual media item and a portion of the avatar of the user commentating on the visual media item within the artificial reality environment.

14. The system of claim 13, wherein:
the visual media item comprises a two-dimensional video; and
configuring the artificial reality environment to display the visual media item comprises modifying the two-dimensional video for display in the designated zone.

15. The system of claim 13 wherein configuring the artificial reality environment further comprises re-lighting at least one virtual object to match the-lighting of at least one of:
the visual media item; or
the artificial reality environment.

16. The system of claim 13, wherein:
the visual media item comprises a live media event; and
inserting the visual media item into the artificial reality environment comprises streaming the live media event within the artificial reality environment.

17. The system of claim 13, wherein:
the visual media item comprises a recording; and
inserting the visual media item into the artificial reality environment comprises inserting the recording into the artificial reality environment.

18. The system of claim 13, wherein receiving the user input specifying the visual media item comprises receiving a selection of a type of artificial reality environment into which to insert the visual media item.

19. The system of claim 13, further comprising enabling an additional commentator to commentate with the user on the visual media item within the artificial reality environment by inserting an avatar of the additional commentator into the artificial reality environment.

20. A non-transitory computer-readable medium comprising one or more computer-readable instructions that, when executed by at least one processor of a computing device, cause the computing device to:
receive, from a user, user input specifying a visual media item for insertion into an artificial reality environment, the visual media item comprising three-dimensional media;
determine, in response to receiving the user input, a format of the visual media item;
configure, based on the format of the visual media item, the artificial reality environment to display the visual media item within a designated zone of the artificial reality environment, the designated zone comprising a bounded three-dimensional space for displaying three- dimensional media;
insert the visual media item into the designated zone of the artificial reality environment;
enable the user to commentate on the visual media item within the artificial reality environment by inserting an avatar of the user into the artificial reality environment; and
enable at least one additional user to view, from at least one viewpoint within the artificial reality environment, at least a portion of the visual media item and a portion of the avatar of the user commentating on the visual media item within the artificial reality environment.
